(19) United States
(12) Patent Application Publication
(10) Pub. No.: US 2025/0191868 A1
(43) Pub. Date: Jun. 12, 2025

(54) BUS BAR CURRENT INTERRUPTION DEVICE AND ENERGY STORAGE DEVICE

(71) Applicant: Scania CV AB, Södertälje (SE)

(72) Inventors: Carl TENGSTEDT, Grödinge (SE); Ulf NYLÉN, Rönninge (SE); Ganesh KUMAR, Sundbyberg (SE); Linus NILSSON, Johanneshov (SE); Adam SOBKOWIAK, Uppsala (SE); Andreas PETTERSSON, Rönninge (SE); Zahra BESHARAT, Solna (SE)

(73) Assignee: Scania CV AB, Södertälje (SE)

(21) Appl. No.: 18/842,086

(22) PCT Filed: Feb. 28, 2023
(86) PCT No.: PCT/SE2023/050178

§ 371 Date: Aug. 28, 2024

(30) Foreign Application Priority Data
Mar. 4, 2022 (SE) 2250295-9

(51) Int. Cl. H01H 85/38; H01H 85/02; H01H 85/175; H01H 85/43; H01M 50/505; H01M 50/583

(52) U.S. Cl. CPC H01H 85/38; H01H 85/0241; H01H 85/175; H01H 85/43; H01M 50/505; H01M 50/583; H01H 2085/025

(57) ABSTRACT

A bus bar current interruption device comprising a casing, providing an enclosure, and a bus bar arrangement. The bus bar arrangement is arranged to extend through the enclosure and comprises a first terminal end portion and a second terminal end portion, each of said first and second terminal end portions arranged outside of the casing. The bus bar arrangement further comprised a first fuse portion and a second fuse portion arranged in the enclosure. The casing comprises an exhaust opening configured to allow escape of vapor from the enclosure. The exhaust opening is fluidly connected to an exhaust chamber or conduit formed by the casing or attached to the casing.

### TECHNICAL FIELD

The present disclosure relates in general to a bus bar current interruption device. The present disclosure further relates in general to an energy storage device comprising the bus bar current interruption device. The present disclosure also relates in general to a vehicle comprising such an energy storage device.

### BACKGROUND

The electrification of vehicles has led to great focus on the development of improved energy storage devices for powering propulsion units of vehicles. Such energy storage devices require many battery cells to achieve desired capacity. The most frequently used battery cells today for this purpose are lithium-ion battery cells.

An energy storage device used for powering a vehicle may comprise one or more battery packs. In case the energy storage device comprises a plurality of battery packs, these may be connected in series and/or in parallel. Each battery pack may typically comprise a plurality of battery modules connected in series and/or in parallel. A battery module typically comprises multiple battery cells connected in series and/or parallel, partly or fully encased in a mechanical structure. Other configurations of energy storage devices are also possible, if desired. For example, it is also possible to arrange individual battery cells in a battery pack, without the use of modules.

Short circuits in energy storage devices, such as described above, can result in a fire. The risk is increased with increasing voltage and thus, for example, increases with increasing number of battery cells connected in series. The risk of fire caused by external short circuit may be prevented by a current interruption device arranged for example at a terminal of the energy storage device. This may for example be achieved by a pack fuse. Internal short circuits within the energy storage device might however not be disconnected by such a fuse pack.

It is also previously known to arrange a current interruption device inside an individual battery cell. However, a current interruption device arranged inside an individual battery cell is typically only designed to protect the individual cell in case of overpressure and/or internal short circuit within or over the battery cell.

US 2014/0315051 A1 discloses a rechargeable battery module comprising a plurality of rechargeable batteries, each of the rechargeable batteries including an electrode assembly including a positive electrode and a negative electrode, and a first electrode terminal and a second electrode terminal connected to the electrode assembly. A bus bar electrically connects the rechargeable batteries, the bus bar including a bus bar fuse part. The first electrode terminal is connected to and installed with a current collecting member that connects the electrode assembly and the first electrode terminal. The current collecting member includes a current collecting fuse part. An operation current at which the bus bar fuse part is melted is less than an operation current at which the current collecting fuse part is melted. The bus bar includes a first fuse part and a second fuse part separated from each other in a width direction of the bus bar by a curved fuse groove, said curved fuse groove being formed at the center in the length direction of the bus bar. It is described that, since current has a characteristic that it flows through the shortest path, current does not prefer to flow through the fuse groove but instead flows through the first and second fuse parts. When an overcurrent is generated, the first and second fuse parts are therefore melted before the curved fuse groove. Upon melting of the curved fuse groove, the current is blocked.

### SUMMARY

The object of the present invention is to provide a device that can safely and quickly disconnect an internal short circuit within an energy storage device comprising a plurality of battery cells.

The object is achieved by the subject-matter of the appended independent claim(s).

In accordance with the present disclosure, a bus bar current interruption device is provided. The bus bar current interruption device comprises a casing providing an enclosure. The bus bar current interruption device further comprises a bus bar arrangement arranged to extend through the enclosure and comprising a first terminal end portion and a second terminal end portion. Each of said first and second terminal portions are arranged outside of the casing. The bus bar arrangement comprises a first fuse portion and a second fuse portion arranged in the enclosure. Furthermore, the casing comprises an exhaust opening configured to allow escape of vapor from the enclosure. The exhaust opening is fluidly connected to an exhaust chamber or conduit. The exhaust chamber or conduit is formed by the casing or is attached to the casing.

The bus bar current interruption device allows breaking of an electrical circuit through the bus bar current interruption device by melting of the first and second fuse portions when the current therethrough reaches a predetermined threshold, for example in case of short circuit. Furthermore, the bus bar current interruption device allows vapor formed when the first fuse portion and/or the second fuse portion are melted to escape from the enclosure in which the first fuse portion and the second fuse portion are arranged. Thereby, long lived plasma and/or arcs resulting from the melting of the first and/or second fuse portion is prevented. This in turn also reduces the risk for reigniting material from the fuse portions. Moreover, due to the exhaust opening, potential spraying of molten material from the first and/or second fuse portion may occur in a controlled manner. Therefore, the bus bar current interruption device is able to safely and quickly break an electrical circuit in which the bus bar current interruption device is arranged.

Previously known current interruption devices designed for high voltages and high currents usually comprise a fuse arranged in an enclosure filled with sand in order to quench arcs and plasma. This results in such current interruption devices being quite large and it may therefore be difficult to arrange such current interruption devices in an energy storage device. However, since the bus bar current interruption device according to the present disclosure is configured to allow the vapor and potential molten particles formed when the first and second fuse portions melt to escape from the enclosure, there is no need for a quenching material inside the enclosure of the bus bar current interruption device, and the device can therefore be made smaller. Therefore, the present bus bar current interruption device may be more easily arranged in an energy storage device, such as an energy storage device of a vehicle.

The exhaust chamber or conduit may have a geometrical shape configured to assist in arc-quenching. Thereby, a quicker extinction of an electrical arc and quenching of a plasma may be achieved. This in turn increases the safety of the bus bar current interruption device. Moreover, a sound damping effect may be achieved.

The exhaust chamber or conduit may contain a filler material capable of arc-quenching. Thereby, a quicker extinction of an electrical arc and quenching of a plasma may be achieved. This in turn increases the safety of the bus bar current interruption device. Moreover, a sound damping effect may be achieved.

The exhaust chamber or conduit may comprise a vent opening configured to allow at least a part of the vapor entering through the exhaust chamber or conduit to escape to the atmosphere surrounding the current interruption device after having passed through the exhaust chamber or conduit. Thereby, the safety of the bus bar current interruption device may be further improved. Moreover, by selection of the position of such a vent opening it can be assured that vapor leaves the bus bar current interruption device in a safe direction which does not risk causing any damage to for example surrounding components and/or people that may be handling the bus bar current interruption device during or after an electrical short circuit is a fact.

The first fuse portion and the second fuse portion may be configured to melt in a sequential order such that the second fuse portion will melt after the first fuse portion has melted, wherein the melting of the second fuse portion permanently breaks an electrical circuit through the bus bar arrangement. Thereby, at the time when the electrical circuit is broken and the electrical arc is formed, less material will spray and less material will be evaporated and ionized. This in turn facilitates the quenching of the electrical arc and the plasma, and thus increases the safety of the bus bar current interruption device.

The first fuse portion may have a smaller cross-sectional area than the cross-sectional area of the second fuse portion. Thereby, the first and second fuse portions will melt in a sequential order which increases the safety of the bus bar current interruption device.

The exhaust opening may be arranged adjacent to the second fuse portion. Thereby, vapor formed when the second fuse portion melts may be easily evacuated. This in turn increases the safety of the bus bar current interruption device.

The bus bar current interruption device may further comprise a separation member arranged between the first fuse portion and the second fuse portion. Thereby, the risk of spraying of molten metal between the fuse portion which could reignite an electrical arc is further reduced. This in turn further improves the safety of the bus bar current interruption device.

The first fuse portion and the second fuse portion may be formed in a plate-like portion of the bus bar arrangement and be separated from each other by at least one through-hole in the plate-like portion.

The exhaust opening may have a longitudinal extension parallel to a longitudinal axis of the plate-like portion of the bus bar arrangement, said longitudinal extension of the exhaust opening being equal to or greater than an extension of the second fuse portion in a direction parallel to the longitudinal axis of the plate-like portion. This facilitates the escape of vapor and molten metal particulates from the enclosure and thus further increases the safety of the bus bar current interruption device.

The bus bar current interruption device may, if desired, further comprise a third fuse portion. Such a third fuse portion may be configured to melt prior to the second fuse portion is melted. Thereby, the safety of the bus bar current interruption device may be further increased.

The bus bar current interruption device according to the present disclosure may be designed for use at high voltages and high currents. The bus bar current interruption device may be configured to permanently break an electrical circuit through the bus bar arrangement at voltages above 500 V and currents above 800 A, preferably currents equal to or above 1000 A.

The present disclosure further provides an energy storage device comprising the bus bar current interruption device as described above. The energy storage device may comprise a plurality of electrochemical cells, such as lithium-ion electrochemical cells or sodium-ion electrochemical cells, connected in series and/or in parallel. In view of the bus bar current interruption device, the energy storage device inter alia has a reduced risk for internal short circuit. Therefore, there is also a reduced risk for fire. The energy storage device will also, as a result of the bus bar current interruption device, be less sensitive to external short circuit of the energy storage device.

The energy storage device may for example comprise a first battery module and a second battery module. In such a case, the bus bar current interruption device as described herein may be arranged to electrically connect the first battery module with the second battery module.

The present disclosure further provides a vehicle comprising the energy storage device as described above. The vehicle may for example be a fully electrical vehicle or a hybrid vehicle. The vehicle may be a heavy vehicle, such as a truck or a bus, but is not limited thereto.

### BRIEF DESCRIPTION OF DRAWINGS

FIG. 1 schematically illustrates an example of an energy storage device,

FIG. 2 schematically illustrates a perspective view of an example of a battery module,

FIG. 3a represents a cross sectional view illustrating a first exemplifying embodiment of a bus bar current interruption device according to the present disclosure,

FIG. 3b represents a cross sectional view of the casing of the bus bar current interruption device shown in FIG. 3a,

FIG. 4 represents a cross sectional view of a second exemplifying embodiment of a bus bar current interruption device according to the present disclosure,

FIG. 5 represents a cross sectional view of a third exemplifying embodiment of a bus bar current interruption device according to the present disclosure,

FIG. 6a represents a perspective view of a fourth exemplifying embodiment of a bus bar current interruption device according to the present disclosure,

FIG. 6b represents a perspective view of the bus bar arrangement of the bus bar current interruption device shown in FIG. 6a,

FIG. 6c represents a perspective view of the bus bar current interruption device shown in FIG. 6a when a part of the casing has been removed,

FIG. 7 schematically illustrates a side view of an example of a vehicle comprising an energy storage device.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In the present disclosure, a current interruption device is considered to mean a device configured to cut off an electrical circuit for the purpose of preventing an incident such as a short circuit or overload. A current interruption device may be configured to cut off the electrical circuit temporarily or permanently. The bus bar current interruption device as described herein is intended to permanently cut off an electrical circuit. Moreover, the bus bar current interruption device as described herein may be considered to be a fuse type current interruption device.

Furthermore, a fuse portion is considered to mean an electrically conducting portion configured to melt when subjected to a current above a predetermined threshold, thereby preventing current to flow through the fuse portion.

In accordance with the present disclosure, a bus bar current interruption device is provided. The bus bar current interruption device is primarily developed for the purpose of safely and quickly break an electrical circuit in case of internal short circuit within an energy storage device comprising a plurality of battery cells. It may however also be used for the purpose of breaking an electrical circuit in case of an external short circuit of an energy storage device.

Furthermore, the bus bar current interruption device has primarily been developed for energy storage devices of land-based vehicles, including for example heavy vehicles such as trucks or busses. It may also be used for energy storage devices in other types of vehicles, such as watercrafts or aircrafts. Furthermore, the bus bar current interruption device may be used in a large variety of other applications, such as in off-grid energy storage solutions for various purposes.

The bus bar current interruption device according to the present disclosure comprises a casing, forming an enclosure, and a bus bar arrangement. The bus bar arrangement is arranged to extend through the enclosure and comprises a first terminal end portion and a second terminal end portion. Each of the first terminal end portion and the second terminal end portion are arranged outside of the casing. The first and second terminal end portions are configured to allow electrical connection of the bus bar interruption device to other constituent components of an electrical circuit. The bus bar arrangement comprises at least a first fuse portion and a second fuse portion arranged in the enclosure provided by the casing. The casing comprises at least one exhaust opening configured to allow escape of vapor from the enclosure. More specifically, the at least one exhaust opening is configured to allow escape of vapor formed inside the enclosure when the first and/or second fuse portion are melted. The bus bar current interruption device further comprises an exhaust chamber or conduit. The exhaust chamber or conduit may be formed by the casing or may be a separate component attached to the casing. The exhaust opening is fluidly connected to the exhaust chamber or conduit. Thereby, vapor escaping from the enclosure is led, via the exhaust opening, into the exhaust chamber or conduit. The exhaust chamber or conduit may be configured to function as an arcing chamber.

The first and second fuse portions are made of a metallic material. When such a fuse portion is subjected to a current that is above a predetermined threshold, the fuse portion will melt and, at least in some situations, an electrical arc may be formed which in turn may ignite a plasma. The melting of the fuse portion is intended to break the electrical current passing through the fuse portion. However, the melting of the fuse portion may also lead to a spray of molten material as well as evaporation of metal from the fuse portion. The evaporated metal may be ionized (charged) by the electrical arc leading to a longer-lived plasma and even risk of formation of new electrical arcs. This may in turn result in that the electrical circuit is in fact not broken as intended. The present bus bar current interruption device is however configured so that vapor, including evaporated metal, formed when a fuse portion melts can escape from the enclosure through the exhaust opening. This reduces the risk of a long-lived electrical arc. Furthermore, it significantly reduces the time a plasma may be sustained in the enclosure.

Preferably, the at least one exhaust opening is also configured to allow sprayed molten metal to escape from the enclosure. This may be achieved inter alia by adjusting the size of the exhaust opening and/or the position of the exhaust opening in relation to the first and/or second fuse portion as will be further described below. The flow of vapor from the enclosure will likely also assist sprayed molten metal to exit the enclosure.

As mentioned above, the casing forms an enclosure through which the bus bar arrangement extends. The enclosure may suitably have a size and an internal shape that essentially corresponds to the outer shape of the part of the bus bar arrangement extending therethrough. This minimizes the risk of spraying of molten metal from one of the fuse portions to the other fuse portion. In other words, the enclosure may suitably have a geometrical shape and size just enough to be able to fit the bus bar arrangement (except for the terminal end portions thereof) in the enclosure. The enclosure need not be, and is not intended to be, filled with any filler material, such as sand, for arc-quenching. The enclosure and/or the bus bar arrangement may however comprise a coating of a composition capable of arc quenching, without departing from claimed scope of the present invention. Such compositions may be polymeric compositions and are as such known in the art and will therefore not be further described in the present disclosure. Alternatively, or additionally, the enclosure and/or bus bar arrangement may further comprise an anti-flame coating material, such as a boron-based anti-flame coating material, without departing from the claimed scope of the present invention.

The casing is a protective casing and should thus be formed of a material which is electrically insulating. Moreover, the casing should preferably be made of a material having low weight. Therefore, the casing may suitably be made of a polymeric material. Examples of suitable materials include aramid, nylon or polyurethane, which may or may not be fiber reinforced. Other polymeric materials are also plausible.

As mentioned above, the at least one exhaust opening is fluidly connected to an exhaust chamber or conduit. In case the casing comprises a plurality of exhaust openings, these may suitably be fluidly connected to the same exhaust chamber or conduit. The exhaust chamber or conduit is separate from the enclosure. However, the exhaust chamber or conduit may suitably be integrated into the same casing as the enclosure. Alternatively, the exhaust chamber or conduit is formed as a separate component which is firmly attached to the casing. Such an attachment may be made by fusing or welding.

The purpose of the exhaust chamber or conduit is primarily to enable fast and reliable arc-quenching. Therefore, the exhaust chamber or conduit preferably has a geometrical shape configured to assist in arc-quenching. In particular, the length of the flow path of vapor and the length of the flow path of possible molten particles in the exhaust chamber or conduit influence the ability to quickly quench electrical arcs and possible plasma. The exhaust chamber or conduit may have a geometrical shape configured to create and/or increase turbulence in the vapor flow, which also assists in arc-quenching. In other words, the geometrical shape of the exhaust chamber or conduit may be selected such that it functions as a kinetic filter. The exhaust chamber or conduit may for example comprise one or more members protruding from a wall of the exhaust chamber and arranged so as to create a meandering flow path through the exhaust chamber or conduit. A meandering flow path is in the present disclosure considered to be a flow path that alters directions of the flow (e.g. to make it tumble), and includes for example a zig-zag flow path or a sinusoidal flow path.

Alternatively, or additionally, the exhaust chamber or conduit may contain a filler material capable of arc quenching. Such a filler material should be able to cool and deionize evaporated and molten material. Therefore, the filler material may be an insulating material. The filler material may be in particulate form, fiber form and/or in the form of one or more porous solid bodies manufactured from particulates and/or fibers. Examples of suitable filler materials include, but are not limited to, sand, glass fiber or other ceramic material, such as zeolite. Alternatively, the filler material may be formed of a metal mesh or metal wool. Two or more filler materials may be used, if desired. The filler material(s) may be present in only a portion of the exhaust chamber or conduit, or may substantially fill the internal volume of the exhaust chamber or conduit.

The exhaust chamber or conduit, at least when having a geometrical shape configured to assist in arc-quenching and/or containing a filler material, also has the advantage of dampening the sound when the electrical circuit is broken. Thereby, the risk of inflicting hearing injuries to people in the proximity is significantly reduced.

The exhaust chamber or conduit may possibly be a sealed space except for the exhaust opening. However, in order to further improve the safety, the exhaust chamber or conduit preferably also comprises a vent opening configured to allow at least part of the vapor entering through the exhaust opening to escape to the atmosphere surrounding the current interruption device after having passed through the exhaust chamber or conduit. This minimizes the risk of an overpressure inside the current interruption device and further assist in fast arc-quenching. Moreover, the exhaust chamber or conduit can be made smaller in case of comprising such a vent opening compared to a case where it provides a sealed space.

As mentioned above, the bus bar current interruption device comprises a bus bar arrangement comprising a first and second terminal end portion as well as a first and second fuse portion. The bus bar arrangement may consist of a single plate-like bus bar member, which may be straight or bent as desired. In such a case, the first and second terminal end portions may be formed of longitudinally opposing end portions of the single plate-like member. Moreover, the first and second fuse portions may be formed by removing material in a portion between the first and second terminal end portions so as to form one or more through-holes in the single plate-like bus bar member. In other words, the first and second fuse portions are separated from each other by said one or more through-holes. Alternatively, the bus bar arrangement may comprise a plurality of constituent bus bar components. For example, the first and second terminal end portions may be formed of different constituent bus bar components. The different constituent bus bar components may be welded or otherwise fastened to each other so as to form the bus bar arrangement.

Irrespectively of whether the bus bar arrangement consists of a single plate-like member or comprises a plurality of constituent bus bar components, the bus bar arrangement may comprise a plate-like portion in which the first fuse portion and the second fuse portion are formed. The first fuse portion and the second fuse portion may be separated from each other by at least one through-hole in the plate-like portion. Such a through-hole may be formed by any previously known method therefore, such as stamping. The first fuse portion and the second fuse portion may be arranged to be substantially parallel. Moreover, the first fuse portion and the second fuse portion may have a substantially equal length. The length is here intended to mean the distance that the current needs to travel in order to pass from one end of the fuse portion to the other end of the fuse portion. It is however also possible that the second fuse portion has a different length, for example being longer, than the first fuse portion.

At least the plate-like portion of the bus bar arrangement may suitably be made of copper, a copper-based alloy, aluminum, an aluminum-based alloy, silver, or a silver-based alloy. In other words, the first fuse portion and the second fuse portion may be made of copper, a copper-based alloy, aluminum, an aluminum-based alloy, silver, or a silver-based alloy. The whole bus bar arrangement may be made of the same material, or different constituent bus bar components may be made of different electrically conducting materials if desired. It is however also possible to construct the fuse portions of different materials, if desired.

The first fuse portion and the second fuse portion may be configured to melt in a sequential order such that the second fuse portion will melt after the first fuse portion has already melted. In such a case, the electrical circuit through the bus bar arrangement is broken only upon the melting of the second fuse portion. This has the advantage of allowing melting of the first fuse portion with less spray of molten metal therefrom and a considerably reduced risk for arc forming during said melting. This also means a lower risk for ionization of evaporated metal. When the second fuse portion thereafter melts, less metal spray and evaporated metal will be formed at the same time compared to a case where the first and the second fuse portions melt at the same time. Therefore, the risk of long-lived electrical arc and/or plasma is significantly reduced.

The first fuse portion may have a smaller cross-sectional area than the cross-sectional area of the second fuse portion. Thereby, it may be ensured that the first fuse portion will melt before the second fuse portion will melt. In other words, the first fuse portion and the second fuse portion may be configured to melt in a sequential order as a result of having different cross-sectional areas.

As previously mentioned, the casing comprises at least one exhaust opening configured to allow escape of vapor and preferably also sprayed molten metal particles from the enclosure. In order to facilitate such an escape from the enclosure, the exhaust opening should be arranged in the vicinity of the first and/or the second fuse portion. Suitably, the exhaust opening is arranged adjacent to one of the first and second fuse portions. In case the first and second fuse portions are configured to melt in a sequential order such that the second fuse portion is the last one to melt, the at least one exhaust opening is suitably arranged closer to the second fuse portion. This is because more metal spray and ionization of evaporated metal will occur at the second fuse portion than at the first fuse portion. It is desired that the sprayed molten metal originating from the second fuse portion does not reach the already melted first fuse portion as this could reignite the melted first fuse portion, which in turn may mean that the electrical circuit is not broken as intended. Therefore, it is important to evacuate as much as possible of the material resulting from the melting of the second fuse portion from the enclosure. Therefore, the at least one exhaust opening should preferably be arranged closer to the second fuse portion than to the first fuse portion. It is however also plausible to include further exhaust openings as previously mentioned. For example, a second exhaust opening may be arranged in the close vicinity of, such as adjacent to, the first fuse portion to further increase the safety of the bus bar current interruption device.

In order to further reduce the risk of molten metal spray originating from one of the first fuse portion and the second fuse portion to reach the position of the other one of the first fuse portion and second fuse portion, the bus bar current interruption device may further comprise a separation member arranged between the first fuse portion and the second fuse portion. Such a separation member should be made of a protective material which is electrically isolating. The separation member may for example be made of the same material as the casing. In fact, the separation member may be integrated with the casing such that it forms a part of the casing. The separation member suitably extends through the at least one through hole separating the first and second fuse portions. Moreover, the separation member may have an outer geometry and shape essentially corresponding to the shape of the at least one through-hole in the plate-like portion of the bus bar arrangement. In case the plate-like portion comprises a plurality of through-holes separating the first fuse portion from the second fuse portion, each of said through-holes may comprise a separation member. In other words, the bus bar current interruption device may comprise a plurality of separation members.

The exhaust opening should suitably have a size that facilitates the escape of vapor and sprayed molten metal from the enclosure. An increase in the amount of material originating from the melted fuse portions that may escape from the enclosure generally result in a lower risk for a long-lived electrical arc and/or plasma. Therefore, the at least one exhaust opening may suitably have a longitudinal extension parallel to a longitudinal axis of the plate-like portion of the bus bar arrangement which is equal to or greater than an extension of the second fuse in a direction parallel to the longitudinal axis of the plate-like portion. Moreover, the at least one exhaust opening should preferably have an extension perpendicular to said longitudinal extension which is substantially the same as the thickness of the second fuse portion seen in the same direction.

The bus bar arrangement may comprise further fuse portions arranged in the plate-like portion thereof. The bus bar arrangement may for example, in addition to the first fuse portion and the second fuse portion, comprise a third fuse portion. If so, the fuse portions may also be configured to melt in a sequential order for the same reason as described above with regard to the possible sequential melting of the first fuse portion and the second fuse portion. If so, the third fuse portion may be configured to melt prior to the melting of the second fuse portion. In other words, the second fuse portion is always the fuse portion that melts last and thus permanently breaks the electrical circuit through the bus bar arrangement. The third fuse portion may be configured to melt simultaneously with, before or after the melting of the first fuse portion. The third fuse portion may be arranged between the first fuse portion and the second fuse portion. In such a case, the third fuse portion may preferably be configured to melt prior to the first fuse portion, at least if there is no exhaust opening directly adjacent thereto.

The bus bar current interruption device as described herein is intended to be used in high voltage and high current applications, such as in an energy storage device of a vehicle. Such an energy storage device comprises a large number of battery cells which may be ordered in a plurality of battery modules and/or one or more battery packs. The battery cells may be selected from the lithium-ion electrochemical cells, sodium-ion electrochemical cells or any other high-energetic electrochemical cells. The bus bar current interruption device may be arranged within the energy storage device. Furthermore, the bus bar current interruption device may for example be configured to permanently break an electrical circuit through the bus bar arrangement at voltages above 500 V and currents above 800 A, preferably currents equal to or above 1000 A. The actual threshold for when the electrical circuit is to be permanently broken by the bus bar current interruption device may be chosen by proper selection of the size and material of the fuse portions.

The bus bar current interruption device as described herein may be configured to break an electrical circuit through the bus bar arrangement within a preselected time tailored for an intended use of the bus bar current interruption device. More specifically, by selecting the cross-sectional area of the respective fuse portions, the time until the fuse portions melt such that the electrical circuit is broken may be tailored. In certain cases, depending on if it would affect the operation of other current interruption devices of a system wherein the bus bar current interruption device according to the present disclosure is incorporated, it may be desired that the herein described bus bar current interruption device does not break the electrical circuit through the bus bar arrangement too quickly. The bus bar current interruption device according to the present disclosure may for example be configured to break an electrical circuit in less than 45 ms, or in less than 30 ms. Furthermore, the bus bar current interruption device may alternatively, or additionally be configured to break the electrical circuit after more than 5 ms, or more than 8 ms.

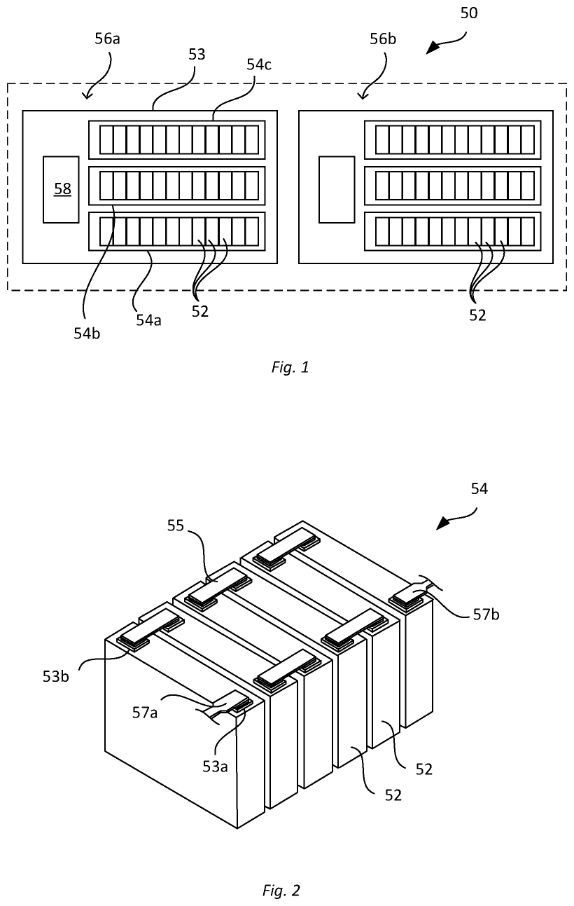

FIG. 1 schematically illustrates an example of an energy storage device 50. The energy storage device 50 comprises a plurality of battery cells 52. The battery cells 52 may be arranged in one or more battery modules 54a, 54b, 54c, which in turn may be arranged in a first battery pack 56a. The first battery pack may be partly or fully enclosed by a protective cover 53. The different battery modules 54a, 54b, 54c, of the first battery pack 56a, may each have the same configuration such as number of battery cells 52 and how they are coupled to each other. Alternatively, the configuration of the different battery modules 54a, 54b, 54c within the first battery pack 56a may be different. The first battery pack 56a may, in addition to the battery modules 54a, 54b, 54c, comprise a battery management system 58 configured to control the battery pack.

As shown in the figure, the energy storage device 50 may further comprise a second battery pack 56b. The second battery pack 56b may have the same configuration as the first battery pack 56a, as shown in the figure, or may have a different configuration than the first battery pack 56a. The second battery pack 56b, if present, also comprises a plurality of battery cells 52. The energy storage device 50 may, if desired, comprise further battery packs. The battery packs 56a, 56b of the energy storage device 50 may be connected in series or in parallel.

It should be noted that the energy storage device 50 need not comprise one or more battery packs but could for example comprise a plurality of individual battery modules (such as the battery modules 54a, 54b, 54c), which are not arranged in battery packs. The plurality of battery modules may be connected in series and/or in parallel.

FIG. 2 schematically illustrates an example of a battery module 54. The battery module 54 comprises a plurality of battery cells 52 which may be stacked. The battery cells 52 may be partly or fully enclosed by a mechanical structure. Such a mechanical structure has been omitted in the figure for sake of simplicity, but is as such previously known. The mechanical structure may for example serve the purpose of holding the battery cells in a stacked arrangement, provide a protective structure, facilitate handling of the module and/or containing a temperature regulating circuit for controlling the temperature of the battery module 54. Each battery cell 52 comprises a first (positive) battery terminal 53a and a second (negative) battery terminal 53b. The battery cells 52 are connected in series via bus bars 55. The bus bars 55 may be welded to the respective terminals 53a, 53b of the battery cells 52 or may be attached thereto by one or more fasteners (not shown), such as a screw or a clamp. A first module terminal 57a may be welded or otherwise fastened to the first of said battery cells connected in series, and a second module terminal 57b may be welded or otherwise fastened to the final of said battery cells connected in series. The module terminals 57a, 57b may be electrically connected to another battery module, an electrical load or the like.

The bus bar current interruption device as described herein may for example be used to replace of one or more of the bus bars 55 shown in the figure and thus to electrically connect two adjacent battery cells to one another. Alternatively, the bus bar current interruption device as described herein may be used to replace one or more of the module terminals 57a, 57b shown in the figure. The bus bar current interruption device as described herein may alternatively be electrically connected to one of the module terminals 57a, 57b. Naturally, a first bus bar current interruption device may be connected to the first module terminal 57a and a second bus bar current interruption device may be connected to the second module terminal 57b, if desired.

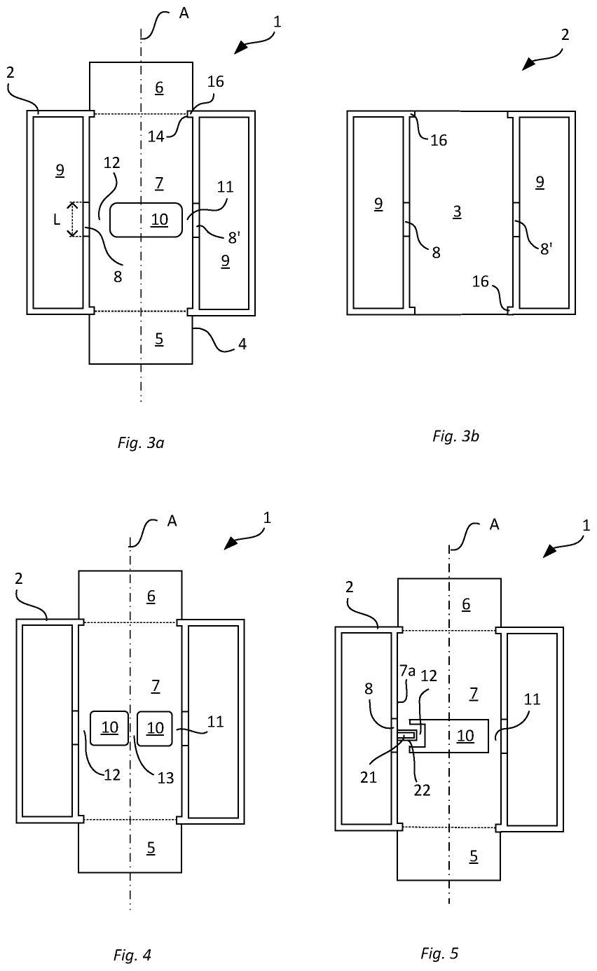

FIG. 3a illustrates a cross-sectional view of a first exemplifying embodiment of a bus bar current interruption device 1 according to the present disclosure. The bus bar current interruption device 1 comprises a casing 2, which is shown in more detail in FIG. 3b, and a bus bar arrangement 4. FIG. 3b represents the same cross section as shown in FIG. 3a. In other words, FIG. 3b corresponds to FIG. 3a with the exception that the bus bar arrangement 4 has been omitted.

The bus bar arrangement 4 of the bus bar current interruption device 1 according to the first exemplifying embodiment is formed of a single plate-like member of an electrically conductive material, such as copper, aluminum or an alloy based on copper or aluminum. The bus bar arrangement 4 comprises a first terminal end portion 5 arranged at a first longitudinal end of the plate-like member and a second terminal end portion 6 arranged at the opposing second longitudinal end of the plate-like member. The bus bar arrangement 4 further comprises a plate-like portion 7 arranged between the first terminal end portion 5 and the second terminal end portion 6. In FIG. 3a, the boundary between the first terminal end portion 5 and the plate-like portion 7 as well as the boundary between the plate-like portion 7 and the second terminal end portion 6 are illustrated by dotted lines. It should here be noted that although the plate-like portion 7 is shown to be directly adjacent to the first terminal end portion 5 as well as directly adjacent to the second terminal end portion 6, the bus bar arrangement 4 may comprise further portions separating the plate-like portion 7 from the first and/or second terminal end portions 5, 6.

The plate-like portion 7 has a longitudinal axis A. The cross-sectional view shown in FIG. 3a is in a plane coinciding with said longitudinal axis A of the plate-like portion 7. In case the bus bar arrangement 4 has a flat configuration, as is illustrated in FIG. 3a, the longitudinal axis A of the plate-like portion 7 naturally coincides with a longitudinal axis of the single plate-like member. It should however be noted that for example one or both of the terminal end portions 5, 6 may be bent relative the longitudinal axis A of the plate-like portion 7, if desired.

The bus bar arrangement 4 extends through the casing 2 such that the first terminal end portion 5 and the second terminal end portion 6 are arranged outside of the casing 2, whereas the plate-like portion 7 is arranged inside the casing 2. The casing 2 encircles the bus bar arrangement 4, except for the first and second terminal portions 5, 6. The casing 2 is a protective casing and may be made of a polymeric material. The casing 2 forms an enclosure 3 (see FIG. 3b) through which the bus bar arrangement 4 extends. More specifically, the enclosure 3 encapsulates the bus bar arrangement 4 except for the first and second terminal end portions 5, 6 which extend out from the casing 2. The bus bar arrangement 4 may comprise a plurality of recesses 14 formed in opposing longitudinally extending sides allowing fastening the bus bar arrangement 4 to the casing 2 by protruding parts 16 of the casing, as shown in the figure. However, other alternatives for mounting the bus bar arrangement 4 in the casing 2 are also plausible.

The enclosure 3 preferably has a shape that essentially corresponds to the outer shape of the part of the bus bar arrangement 4 extending therethrough. In other words, the enclosure 3 preferably has a size and geometrical shape just enough to be able to fit the bus bar arrangement 4 (except for the terminal end portions 5, 6 of the bus bar arrangement 4) in the enclosure 3.

The bus bar arrangement 4 comprises a first fuse portion 11 and a second fuse portion 12 in the plate-like portion 7. The first fuse portion 11 and the second fuse portion 12 are thus arranged in the enclosure 3. The first fuse portion 11 and second fuse portion 12 may be formed by forming a through-hole 10 in the plate-like portion 7 of the bus bar arrangement 4. In other words, the first fuse portion 11 may be separated from the second fuse portion 12 by a through-hole 10 in the first plate-like portion 7. Moreover, the first fuse portion 11 may be arranged to extend in parallel to the second fuse portion 12. Also, the first fuse portion 11 and the second fuse portion 12 may be arranged on opposite sides of the longitudinal axis A.

The first and second fuse portions 11, 12 may be configured to melt in a sequential order such that the second fuse portion will melt after the first fuse portion has melted. An electrical circuit through the bus bar arrangement 4 will thereby not be broken when the first fuse portion 11 melts, but only when the second fuse portion 12 melts. This may be achieved by allowing the second fuse portion 12 to have a greater cross-sectional area than the cross-sectional area of the first fuse portion 11. In a bus bar arrangement 4 formed by a single plate-like member as shown in FIG. 3a, this may be achieved by the second fuse portion 12 having a greater width than the width of the first fuse portion 11 since the thickness of the plate-like portion 7 is constant. The width of the respective fuse portions is here considered to be in a direction perpendicular to the longitudinal axis A.

The casing 2 comprises a first exhaust opening 8 through which vapor and sprayed molten metal may escape from the enclosure 3. The first exhaust opening 8 is fluidly connected to an exhaust chamber or conduit 9 formed by the casing 2. It should here be noted that the exhaust chamber or conduit 9 may alternatively be formed as a separate component which is attached to the casing 2, if desired. It is however preferred that the exhaust chamber or conduit 9 is formed by the same casing as forming the enclosure 3 in order to minimize the number of joints in the protective cover of the bus bar current interruption device.

The casing may also comprise a second exhaust opening 8′ through which vapor may and sprayed molten metal may escape from the enclosure 3. Such a second exhaust opening may be fluidly connected to the same exhaust chamber or conduit 9 as the first exhaust opening 8, as shown in FIGS. 3a and 3b. It is however also possible that the second exhaust opening 8′ is fluidly connected to a different exhaust chamber or conduit than the exhaust chamber or conduit 9, albeit less preferred as it could result in a larger bus bar current interruption device.

The exhaust chamber or conduit 9 inter alia serves the purpose of quickly quenching the electrical arc and plasma formed when the electrical circuit through the bus bar arrangement is broken. In order to further assist in arc-quenching and extinction of plasma, the exhaust chamber or conduit 9 may have a geometrical shape such that it acts as a kinetic filter. Alternatively, or additionally, the exhaust chamber or conduit 9 may contain a filler material capable of arc-quenching, such as sand or glass fiber. A kinetic filter and/or a filler material assist in cooling of molten metal as well as deionizing charged material resulting from the melting of the first and/or second fuse portions.

The first exhaust opening 8 should preferably be arranged as close as possible to the first and second fuse portions 11, 12. In case the first and second fuse portions 11, 12 are configured to melt in a sequential order, the first exhaust opening 8 should be arranged as close as possible to the second fuse portion 12 since this is where the electrical arc will be formed and thus highest risk for spray of molten metal and ionization of metal. Thus, in such a case and if there is only one exhaust opening, the distance between the second fuse portion 12 and the exhaust opening should be smaller than the distance between the first fuse portion and the exhaust opening.

The first exhaust opening 8 may suitably be sufficiently large to allow sprayed molten metal to exit the enclosure. Suitably, the first exhaust opening 8 may have a longitudinal extension L parallel to the longitudinal axis A of the plate-like portion 7 of the bus bar arrangement, said longitudinal extension L of the exhaust opening being equal to or greater than an extension of the second fuse portion in a direction parallel to the longitudinal axis A of the plate-like portion 7. The exhaust opening 8 may suitably also have an extension in a direction perpendicular to the longitudinal extension which is about the same as the thickness of the plate-like portion 7.

Although not shown in FIG. 3a, the bus bar current interruption device may further comprise a separation member arranged between the first fuse portion and the second fuse portion. The purpose of such a separation member is to avoid molten metal spray from one of the fuse portions to reach the position of the other fuse portion, which in worst case could lead to reignition of an electrical arc and that the electrical circuit would not be broken. Such a separation member may be arranged in the through hole 10. The separation member should be made of a protective material and may for example be made of the same material as the casing 2. The separation member could for example be formed by an internal protrusion part of the casing 2.

The exhaust chamber or conduit 9 may optionally also comprise a vent opening (not shown) configured to allow at least part of the vapor entering the exhaust chamber or conduit 9 to escape to the atmosphere surrounding the bus bar current interruption device 1 after having passed through the exhaust chamber or conduit 9. Thereby, the risk of too high pressure inside the bus bar current interruption device which may make it difficult to extinguish the electrical arc and/or the plasma may be avoided. Such a vent opening may suitably be arranged such that any potential molten metal sprayed would be directed in a safe direction if leaving the bus bar current interruption device 1.

FIG. 4 illustrates a cross-sectional view of a second exemplifying embodiment of a bus bar current interruption device 1 according to the present disclosure. The second exemplifying embodiment shown in FIG. 4 corresponds to the first exemplifying embodiment shown in FIG. 3a except that the bus bar current interruption device further comprises a third fuse portion 13. The third fuse portion 13 is arranged in the plate-like portion of the bus bar arrangement 4. In order to achieve three fuse portions, the plate-like portion 10 comprises two through-holes 10.

Similar to the first exemplifying embodiment, the fuse portions of the bus bar current interruption device 1 according to the second exemplifying embodiment may be configured to melt in a sequential order. For example, the third fuse portion 13 may be configured to melt prior to the first fuse portion 11 or simultaneously with the first fuse portion 11, but prior to the melting of the second fuse portion 12.

FIG. 5 illustrates a cross-sectional view of a third exemplifying embodiment of a bus bar current interruption device 1 according to the present disclosure. The third exemplifying embodiment shown in FIG. 5 corresponds to the first exemplifying embodiment shown in FIG. 3a except that the bus bar current interruption device 1 has a different configuration of the second fuse portion 12 (which is may be achieved by a different configuration of the through-hole 10 as shown in the figure). Furthermore, the bus bar current interruption device 1 also comprises a partition member 21.

The partition member 21 is a member formed of a protective material and may be formed of the same material as the casing 2. The partition member 21 may for example be an integrated part of the casing. The partition member 21 serves the purpose of limiting the spray of molten metal between different parts of the second fuse portion 12, and may therefore reduce the time until the electrical circuit is broken when the second fuse portion 13 is melted.

The partition member 21 is arranged so as to extend into a cut-out 22 in a first longitudinal side 7a of the plate-like portion 7. The partition member 21 may suitably be arranged so as to completely fill the cut-out 22. The cut-out 22 and the through-hole 10 defines the shape of the second fuse portion 12 such that the second fuse portion 12 has a U-shape around the partition member 21.

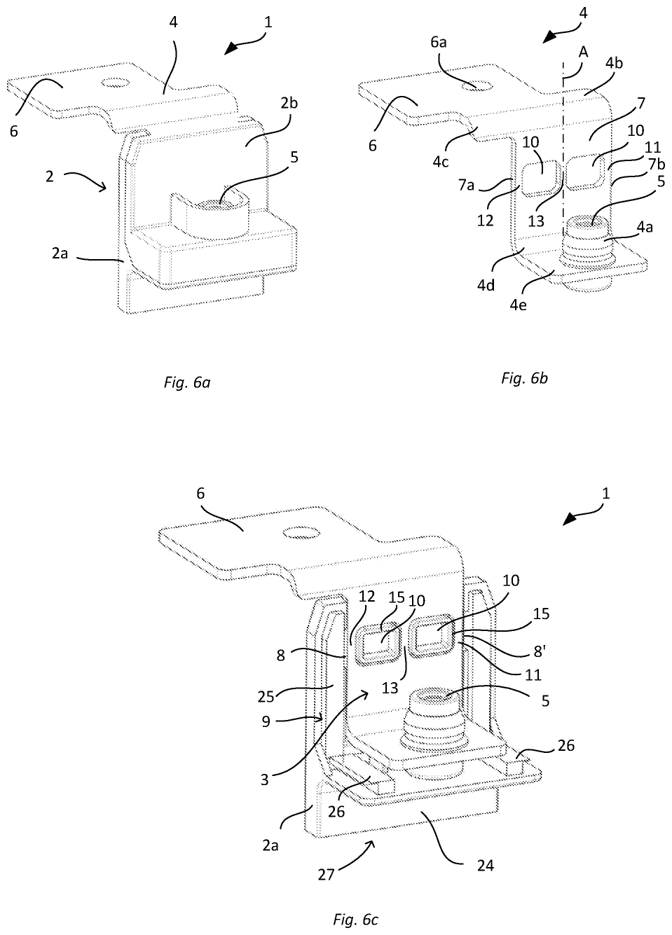

FIG. 6a shows a perspective view of a fourth exemplifying embodiment of the bus bar current interruption device 1 according to the present disclosure. FIG. 6b shows a perspective view of the bus bar arrangement 4 of the bus bar current interruption device 1 of FIG. 6a. Moreover, FIG. 6c shows a perspective view of the bus bar current interruption device 1 shown in FIG. 6a when a first part of the casing has been omitted.

In the fourth exemplifying embodiment of the herein described bus bar current interruption device 1, the bus bar arrangement 4 comprises a plurality of constituent bus bar components as is shown in FIG. 6b. More specifically, the bus bar arrangement 4 comprises a first bus bar component 4a which forms the first terminal end portion 5 of the bus bar arrangement 4. The bus bar arrangement 4 further comprises a second plate-like bus bar component 4b which comprises the second terminal end portion 6 and a plate-like portion 7. The second terminal end portion 6a may optionally comprise a through-hole 6a through which a fastener (not shown) used to mount the bus bar current interruption device 1 to another component of an electrical circuit may extend. The second plate-like bus bar component 4b may comprise a first bend 4c, as shown in FIG. 6b, such that the second terminal end portion 6 is substantially perpendicular to the longitudinal axis A of the plate-like portion 7. The second plate-like bus bar component 4b may also comprise a second bend 4d separating the plate-like portion 7 from an attachment portion 4e to which the first bus bar component 4a is attached. Said attachment portion 4e may be arranged so as to extend perpendicular to the longitudinal axis A of the plate-like portion. The first and second constituent bus bar components 4a, 4b may for example be joined to each other by welding or the like so as to jointly form the bus bar arrangement 4.

As is shown in FIG. 6a, the bus bar arrangement 4 is arranged to extend through the casing 2 such that the first terminal end portion 5 and the second terminal end portion 6 are both arranged outside of the casing 2. Thus, the plate-like portion 7 is arranged inside the casing 2.

As is also shown in FIG. 6a, the bus bar current interruption device 1 according to the fourth exemplifying embodiment comprises a casing 2 formed by two casing parts 2a and 2b. It should however be noted that the casing may alternatively be formed as a single casing part or comprise more than two casing parts. A single casing part may for example be produced by means of injection molding. However, for ease of manufacture, the casing may suitably comprise two casing parts as shown in FIG. 6a. In case the casing 2 comprises a plurality of casing parts, these casing parts may be fused or welded together to jointly form the casing 2.

The plate-like portion 7 comprises a first fuse portion 11, a second fuse portion 12 and a third fuse portion 13, as shown in FIGS. 6b and 6c. The fuse portions 11, 12, 13 are separated from each other by through-holes 10 formed in the plate-like portion 7. It should be noted that although the plate-like portion is shown to comprise three fuse portions, it is also possible that the plate-like portion 7 only comprises a first fuse portion 11 and a second fuse portion 12. In such a case, the plate-like portion 7 need only comprise one through-hole (compare with FIG. 3a). The first, second and third fuse portions 11, 12, 13 may be configured to melt in a sequential order. For example, the third fuse portion 13 may be configured to melt prior to melting of the first fuse portion 11, and the first fuse portion 11 may be configured to melt prior to the melting of the second fuse portion 12. The electrical circuit through the bus bar arrangement 4 and thus the bus bar current interruption device 1 is in such a case broken when the second fuse portion 12 melts.

FIG. 6c represents the current interruption device 1 shown in FIG. 6a, but where the second casing part 2b has been omitted such that the interior of the bus bar current interruption device 1 is visible. The casing 2 provides an enclosure 3 (compare also with FIG. 3b) through which the bus bar arrangement 4 extends. As shown in the figure, the plate-like portion 7 may substantially fill out the enclosure 3. The casing comprises a first exhaust opening 8 configured to allow escape of vapor and sprayed molten metal from the enclosure into an exhaust chamber or conduit 9. The first exhaust opening is arranged adjacent to the second fuse portion 12. The casing 2 further comprises a second exhaust opening 8′ arranged adjacent to the first fuse portion 11. Said second exhaust opening 8′ is fluidly connected to the same exhaust chamber or conduit 9 as the first exhaustion opening 8. The exhaust chamber or conduit 9 thus also has an extension behind the enclosure 3 and the bus bar arrangement in the shown exemplified embodiment.

The exhaust chamber or conduit 9 also extends downwards in the figure inside an extended portion 24 of the casing 2. Said extended portion 24 serves the purpose of providing a sufficiently long flow path for vapor and sprayed molten metal particulates inside the exhaust chamber or conduit to ensure fast and reliable arc-quenching when the electrical circuit through the bus bar arrangement 4 is broken. The bus bar arrangement 4 does not extend into the extended portion 24 of the casing. The extended portion 24 of the casing comprises a vent opening (the position thereof illustrated by arrow 27) at the lower end of the extended portion. Said vent opening constitutes a vent opening of the exhaust chamber or conduit 9 and is configured to allow at least part of the vapor (optionally containing metal particulates) entering the exhaust chamber or conduit 9 via the exhaust openings 8, 8′ to escape to the atmosphere surrounding the bus bar current interruption device 1 after having passed through the exhaust chamber or conduit. Said vent opening is arranged such that the vapor leaving the exhaust chamber or conduit is directed in a controlled manner away from the first terminal end portion 5 as well as the second terminal end portion 6.

The casing 2 further comprises two separation members 15, each arranged so as to protrude through one of the through-holes of the plate-like portion 7. These separation members 15 serves the purpose of avoiding sprayed metal originating from one fuse portion to reach a position of another of the fuse portions. It should here be noted that the separation members 15 need not necessarily be a part of the casing but could be separate components inserted into the through-holes 10.

In order to further assist in the quenching of an electrical arc and quenching of a plasma, the exhaust chamber or conduit 9 may contain a filler material. Such a filler material may be provided in particulate and/or fibrous form such that vapor may flow through the filler material. Alternatively, the filler material may be provided as a porous solid body 25 as shown in FIG. 6c. Such a porous solid body may be manufactured from particulate and/or fibrous material. The filler material assists in the cooling and deionization of the vapor and molten metal particulates that escape from the enclosure 3 when the electrical circuit through the bus bar arrangement 4 is broken. The filler material may be provided in only one portion (preferably close to the exhaust openings 8, 8′) of the exhaust chamber or conduit 9, or in the whole exhaust chamber or conduit 9.

The casing 2 may, if desired, further comprise one or more positioning members 26 configured to ensure correct positioning of the casing parts 2a and 2b in relation to each other when they are assembled. After such an assembling of the casing parts 2a, 2b, the casing parts may be joined to each other.

The bus bar current interruption device 1 according to the fourth exemplifying embodiment illustrated in FIGS. 6a-6c may be modified to further include for example a partition member (which may be an integral part of the casing 2) such as the partition member 21 described with reference to FIG. 5. In such a case, the second fuse portion 12 will have a non-straight extension when seen in parallel to the longitudinal axis A of the plate-like portion 7 and instead forming for example an U-shape around the partition member. Such a partition member may serve the purpose of reducing metal spray originating from one portion of the second fuse portion 12 to reach another portion of the second fuse portion 12 when the second fuse portion melts. Such a partition member may extend through a cut-out (compare with cut-out 22 in FIG. 5) in a first longitudinal side 7a of the plate-like portion 7. Alternatively, or additionally, such a partition member may be arranged to extend through a cut-out in a second longitudinal side 7b of the plate-like portion for the purpose of achieving the same purpose for the first fuse portion 11.

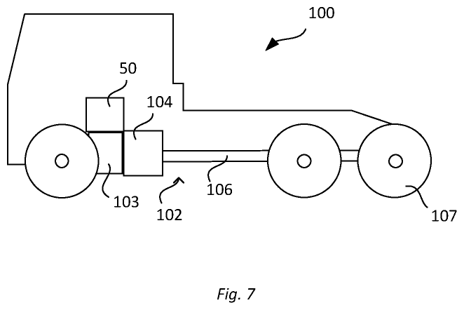

FIG. 7 schematically illustrates a side view of an example of a vehicle 100. The vehicle 100 comprises a powertrain 102. The vehicle powertrain 102 comprises at least one propulsion unit in the form of an electrical machine 103. The electrical machine 103 may be powered by an energy storage device, such as the energy storage device 50 described above. The energy storage device 50 comprises at least one bus bar current interruption device as described herein. The vehicle powertrain 102 of the vehicle 100 may also comprise a gearbox 104 configured to selectively transfer driving torque from the electrical machine 103 to the driving wheels 107. The gearbox 104 may be connected to the driving wheels 107 of the vehicle 100 via a propeller shaft 106.

The vehicle 100 may be a heavy vehicle, such as a truck or a bus, but is not limited thereto. Furthermore, the vehicle may be a fully electrical vehicle or a hybrid vehicle. In the latter case, the vehicle 100 may, in addition to the electrical machine 103 comprise a combustion engine.

1. A bus bar current interruption device comprising:
a casing providing an enclosure; and
a bus bar arrangement arranged to extend through the enclosure, said bus bar arrangement comprising:
a first terminal end portion and a second terminal end portion, each of said first and second terminal end portions arranged outside of the casing; and
a first fuse portion and a second fuse portion arranged in the enclosure,
wherein the casing further comprises an exhaust opening configured to allow escape of vapor from the enclosure, and
wherein the exhaust opening is fluidly connected to an exhaust chamber or conduit formed by the casing or attached to the casing.

2. The bus bar current interruption device according to claim 1, wherein the exhaust chamber or conduit has a geometrical shape configured to assist in arc-quenching.

3. The bus bar current interruption device according to claim 1, wherein the exhaust chamber or conduit contains a filler material capable of arc-quenching.

4. The bus bar current interruption device according to claim 1, wherein the exhaust chamber or conduit comprises a vent opening configured to allow at least part of the vapor entering through the exhaust opening to escape to the atmosphere surrounding the bus bar current interruption device after having passed through the exhaust chamber or conduit.

5. The bus bar current interruption device according to claim 1, wherein the first fuse portion and the second fuse portion are configured to melt in a sequential order such that the second fuse portion will melt after the first fuse portion has melted, wherein the melting of the second fuse portion permanently breaks an electrical circuit through the bus bar arrangement.

6. The bus bar current interruption device according to claim 5, wherein the first fuse portion has a smaller cross-sectional area than a cross-sectional area of the second fuse portion.

7. The bus bar current interruption device according to claim 5, wherein the exhaust opening is arranged adjacent to the second fuse portion.

8. The bus bar current interruption device according to claim 1, further comprising a separation member arranged between the first fuse portion and the second fuse portion.

9. The bus bar current interruption device according to claim 1, wherein the first fuse portion and the second fuse portion are formed in a plate-like portion of the bus bar arrangement and are separated from each other by at least one through-hole in the plate-like portion.

10. The bus bar interruption device according to claim 9, wherein the exhaust opening has a longitudinal extension parallel to a longitudinal axis of the plate-like portion of the bus bar arrangement, the longitudinal extension of the exhaust opening being equal to or greater than an extension of the second fuse portion in a direction parallel to the longitudinal axis of the plate-like portion.

11. The bus bar current interruption device according to claim 1, wherein the bus bar arrangement further comprises a third fuse portion,
wherein the third fuse portion is configured to melt prior to the second fuse portion being melted.

12. The bus bar current interruption device according to claim 1, wherein the bus bar current interruption device is configured to permanently break an electrical circuit through the bus bar arrangement at voltages above 500 V and currents above 800 A.

13. An energy storage device comprising a bus bar current interruption device comprising:
a casing providing an enclosure; and
a bus bar arrangement arranged to extend through the enclosure, said bus bar arrangement comprising:
a first terminal end portion and a second terminal end portion, each of said first and second terminal end portions arranged outside of the casing; and
a first fuse portion and a second fuse portion arranged in the enclosure,
wherein the casing further comprises an exhaust opening configured to allow escape of vapor from the enclosure, and
wherein the exhaust opening is fluidly connected to an exhaust chamber or conduit formed by the casing or attached to the casing.

14. The energy storage device according to claim 13, comprising a first battery module and a second battery module, wherein the bus bar current interruption device is arranged to electrically connect the first battery module with the second battery module.

15. A vehicle comprising an energy storage device comprising a bus bar current interruption device comprising:
a casing providing an enclosure; and
a bus bar arrangement arranged to extend through the enclosure, said bus bar arrangement comprising:
a first terminal end portion and a second terminal end portion, each of said first and second terminal end portions arranged outside of the casing; and
a first fuse portion and a second fuse portion arranged in the enclosure,
wherein the casing further comprises an exhaust opening configured to allow escape of vapor from the enclosure, and
wherein the exhaust opening is fluidly connected to an exhaust chamber or conduit formed by the casing or attached to the casing.

16. The bus bar current interruption device according to claim 1, wherein the bus bar current interruption device is configured to permanently break an electrical circuit through the bus bar arrangement at voltages above 500 V and currents equal to or above 1000 A.
